(19) United States
(12) Patent Application Publication
(10) Pub. No.: US 2003/0093549 A1
(43) Pub. Date: May 15, 2003

(54) Data transfer device including communication circuit for controlling communication party

(75) Inventor: Kazunari Akaogi, Chiba (JP)

Correspondence Address: OLIFF & BERRIDGE, PLC, P.O. BOX 19928, ALEXANDRIA, VA, 22320, US

(73) Assignee: Kawasaki Microelectronics, Inc., Mihama-ku (JP)

(21) Appl. No.: 10/269,883

(22) Filed: Oct. 15, 2002

(30) Foreign Application Priority Data
Oct. 19, 2001 (JP) 2001-321888
Sep. 20, 2002 (JP) 2002-275148

(51) Int. Cl. G06F 15/16

(52) U.S. Cl. 709/234; 709/250

(57) ABSTRACT

A data transfer device is provided which can perform time management of data transfer in real time for effective use of communication channels. The data transfer device according to the present invention includes a memory for storing firmware for controlling data transfer and a communication circuit for transferring data under control of the firmware. The communication circuit has a timer for measuring a time. In accordance with the measured value of the timer, a communicating party is controlled by the communication circuit independently from the control by the firmware. Here, controlling the communicating party includes to perform polling on the communicating party and to disconnect the link with the communicating party when the polled communicating party does not respond.

### BACKGROUND OF THE INVENTION

1. Field of the Invention

The present invention relates to a data transfer device for transferring (exchanging) data to a communicating party, and more particularly to a data transfer device, which may be suitably used for short distance radio communication protocols such as Bluetooth.

2. Description of the Related Art

FIG. 5 is a conceptual diagram of an example showing a connection state between conventional data transfer devices. FIG. 5 shows a state where a host device 30 and four devices 1 to 4, all of which are data transfer devices, are connected to each other. While the host device 30 and the four devices 1 to 4, which are connected to the host device 30, are distinguished in FIG. 5, the host device 30 will be described below as a typical example since the internal constructions of the host device 30 and the four devices 1 to 4 are basically the same.

The host device 30 includes a memory (non-volatile memory) 32, a memory (volatile memory) 36 and a communication circuit 34. The memory 32 stores firmware for controlling data transfer (which will be called firmware 32 below). The memory 36 holds data to be transferred. The communication circuit 34 transfers data under control of the firmware 32.

In the host device 30, the firmware 32 is software for controlling operations of the host device 30 and has a function using a timer (software) 38 for measuring a time and a function for controlling the memory 36. The expression, “under control of firmware” means that a CPU, not shown, executes the firmware so as to control a memory, a communication circuit and so on. The communication circuit 34 is hardware for transferring data physically between the host device 30 and the devices 1 to 4. The communication circuit 34 includes a buffer 40 for temporally holding data to be transferred.

In a conventional data transfer device, data transfer is controlled by firmware, as described above. In other words, in order to secure an amount of data traffic for communicating with a communicating party (that is, communication quality), data transmission paths, that is, communication channels are assigned to devices 1 to 4, respectively, and data to be sent through each of the channels is written into the buffer 40 of the communication circuit 34 by firmware. In order to maintain a link with the communicating party, a time receiving no responses from the communicating party may be measured by using the timer 38. Then, the link to the communicating party not responding for a certain period of time is disconnected.

For example, an operation of the conventional data transfer device will be described with reference to a timing chart shown in FIG. 6.

First of all, in the host device 30, under control of firmware, data to be sent to the device 1 is read out of the memory 36 and written into the buffer 40 of the communication circuit 34. Then, the data transfer is instructed. Thus, the communication circuit 34 transfers (sends) the data written in the buffer 40 to the device 1. When the device 1 receives the data, the device 1 responds to the host device 30. The host device 30 realizes that the data has been sent to the device 1 by receiving the response from the device 1.

Subsequently, in the firmware of the host device 30, other processing than sending data to the device 1 is performed. The firmware not only transfers data to a communicating party but also controls other operations of the host device 30. In this period, the processing for transferring data to a communicating party is interrupted. Thus, the data transfer processing cannot be performed in real time. This problem becomes significant when the transfer speed is very low between the memory 36 controlled by the firmware and the buffer 40 of the communication circuit 34, such as serial transfer.

Then, under control of the firmware of the host device 30, polling to the device 2 is requested to the communication circuit 34. The polling request is used when a host device prompts another device to send information message. The polling request is performed periodically to maintain the links between the host device 30 and the devices 1 to 4 when no data is to be transferred. Thus, polling is performed from the communication circuit 34 of the host device 30 to the device 2. Here, the device 2 responds to the host device 30 since the link with the host device 30 is maintained.

Next, after an idle period, under control of firmware 32 of the host device 30, data to be sent to the device 1 is written in the communication circuit 34 again. Then, the data transfer is instructed. Here, in the communication circuit 34, a certain time lag occurs before the data transfer to the device 1 starts actually. The time lag may occur when the data writing into the communication circuit 34 under control of the firmware takes time due to the serial transfer.

Next, under control of the firmware 32, the communication circuit 34 is instructed such that the link with the device 4 becomes invalid. Thus, the link between the host device 30 and the device 4 is disconnected.

In the conventional data transfer device, under control of firmware, communication channels are assigned to the devices 1 to 4, respectively, and/or time management is performed in order to maintain a link with a communicating party, as described above. Thus, the heavy load due to the control by the firmware 32 occurs in the conventional data transfer device. Then, the time management for the data transfer is difficult in real-time. As a result, the communication channels cannot be used effectively.

### SUMMARY OF THE INVENTION

Accordingly, it is an object of the present invention to provide a data transfer device, which can overcome the problems based on the conventional data transfer device and can perform time management for data transfer in real-time. Thus, the communication channels can be used effectively.

In order to achieve the object, according to one aspect of the present invention, there is provided a data transfer device, including a memory for storing firmware for controlling data transfer, and a communication circuit for transferring data under control of the firmware, wherein the communication circuit has a timer for measuring a time and controls a communicating party in accordance with the value measured by the timer independently from the control of the firmware.

Here, the memory for storing the firmware is preferably a nonvolatile memory.

The communication circuit further has at least one buffer provided by corresponding to a communicating party in the one-to-one manner for temporally holding data to be transferred, a transmission path interface for exchanging data with a communicating party through a transmission path and a control circuit for controlling an operation of the communication circuit.

Preferably, the communication circuit further includes a packet creating/decoding circuit for creating a packet from data to be sent to the communicating party, and inputting the packet to the transmission path interface, and for decoding the packet received from the communicating party through the transmission path interface, reconstructing the original data.

The communication circuit may further include a polling packet creating circuit for creating a polling packet in accordance with an instruction from the control circuit for outputting a polling request when the measured value of the timer reaches a predetermined value.

The timer preferably has at least one counter provided by corresponding to a communicating party in the one-to-one manner, and wherein the counter counts every time a communication channel is switched and may be initialized in receipt of a response from a corresponding communicating party.

The control circuit preferably has a function for outputting a polling request signal to a communicating party corresponding to the counter when a count value of the counter reaches to a predetermined value, and for disconnecting a link with the corresponding communicating party when the corresponding communicating party does not respond.

As described above, in the data transfer device of the present invention, the communication circuit has a timer for measuring a time. In accordance with the value measured by the timer, a communicating party can be controlled independently from control by firmware.

Therefore, according to the data transfer device of the present invention, the load on firmware or CPU can be significantly reduced. The communication circuit can perform time management of data transfer and channel assignment in real time, independently from control by firmware. Thus, the communication channels can be used effectively. Since the load on firmware can be reduced, the program code can be reduced. Then, the CPU resource can be used effectively. In addition, since the load on the CPU can be reduced, the cost can be reduced by adopting an inexpensive CPU having lower processing capability. Therefore, the data transfer device of the present invention is advantageous in an embedded LSI product.

### BRIEF DESCRIPTION OF THE DRAWINGS

FIG. 1 is a conceptual diagram of one embodiment showing a state of connecting data transfer devices according to the present invention;

FIG. 2 is a timing chart of one embodiment showing an operation of the data transfer device according to the present invention;

FIG. 3 is a conceptual diagram of one embodiment showing an internal construction of the data transfer device according to the present invention;

FIG. 4 is a conceptual diagram showing a detail of the internal construction of the data transfer device shown in FIG. 3;

FIG. 5 is a conceptual diagram of an example showing a state of connecting conventional data transfer devices; and

FIG. 6 is a timing chart of an example showing an operation of the conventional data transfer device.

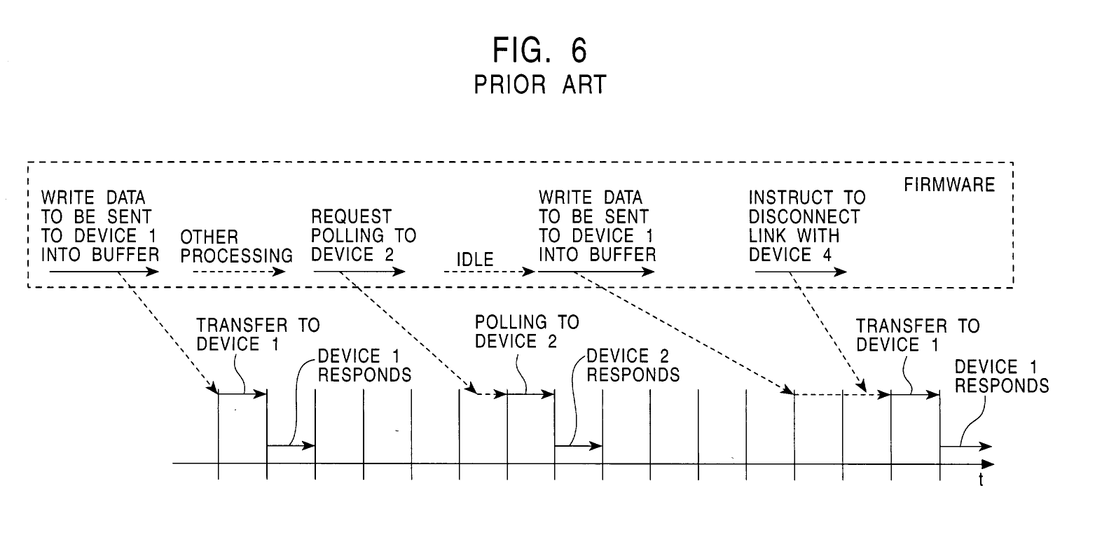

### DESCRIPTION OF THE PREFERRED EMBODIMENTS

A data transfer device according to the present invention will be described below in detail based on a preferred embodiment shown in attached drawings.

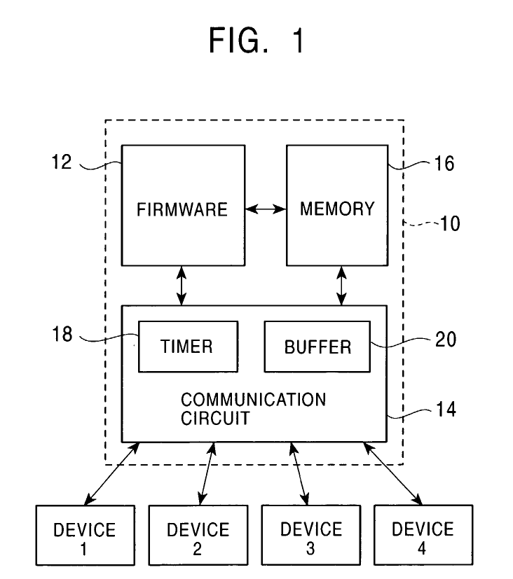

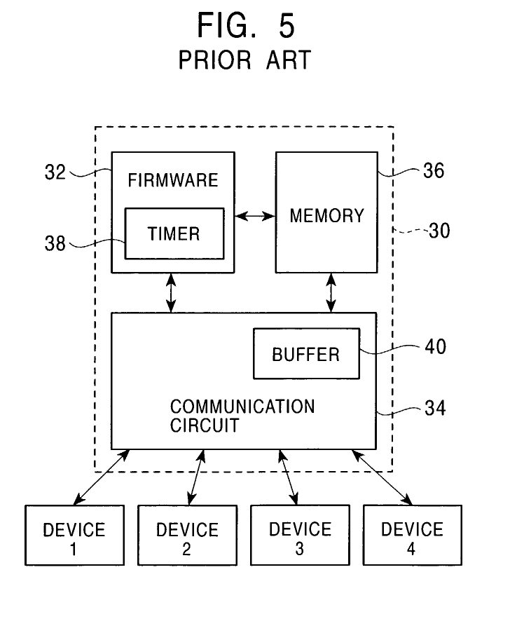

FIG. 1 is a conceptual diagram of one embodiment showing a state of connecting data transfer devices according to the present invention. Like FIG. 5, which is a conventional example, FIG. 1 shows a state of connecting a host device 10 and four devices 1 to 4, all of which are data transfer devices, to each other. A basic difference from FIG. 5 is that a timer function implemented by conventional firmware is moved to a communication circuit 14 in the host device 10 and the devices 1 to 4.

In other words, the host device 10 includes a memory (non-volatile memory) 12, a memory (volatile memory) 16 and a communication circuit 14, like the conventional example. The memory 12 stores firmware for controlling data transfer, which will be also called firmware 12. The memory 16 holds data to be transferred. The communication circuit 14 transfers data under control of the firmware.

In the host device 10, the firmware 12 controls a basic operation of the host device 10 and includes a function for controlling the memory 16. The communication circuit 14 is hardware for transferring data physically between the host device 10 and the devices 1 to 4. The communication circuit 14 includes a timer (hardware) 18 for measuring a time and a buffer 20 for temporally holding data to be transferred.

Here, the timer 18 includes at least one counter provided by corresponding to a communicating party in the one-to-one manner. Therefore, in the example shown in FIG. 1, the timer 18 includes four counters corresponding to the devices 1 to 4, respectively. Unlike the function of the software timer 38 provided in the firmware 32 of the host device 30 shown in FIG. 5, the timer 18 is implemented by hardware. Thus, the timer 18 can operate very fast.

In this embodiment, each of the counters is up-counted every time the communication channel is switched. The counter is initialized when a response is received from each corresponding device. Then, the counter value is cleared (=0).

A maximum limit (monitor value) of count values is predetermined for performing polling to a corresponding device when no data is to be transferred and for disconnecting the link when no responses are received. When the count value of the counter reaches to the monitor value for performing polling, the communication circuit 14 performs polling onto the corresponding devices. Here, when no responses have been received from the corresponding device, the link becomes invalid and the link with the device is disconnected. The monitor value for disconnecting the link can be set separately from the count value for starting polling.

For example, in the case of Bluetooth, which is one of the short-distance radio communication protocols, the channel length (a time unit for communication with one connecting party) is 625 μs. The maximum number of devices is seven. The above-described monitor value is 20 seconds in default. That is, when no responses are received from the communicating party for 20 seconds, the link is disconnected. The time interval for polling is not set in default. A value near 625 μs×20 (count value), for example, is used in general as the time interval for polling. However, these values can be changed freely. Bluetooth adopts the frequency hopping method for performing communication by switching frequencies randomly for every one channel length (unit time). Basically, the host device and the slave device communicate alternately for every one channel length.

In the data transfer device of the present invention, the communication circuit 14 can control a communicating party independently from the control of firmware. That is, the communication circuit 14 assigns communication channels to the devices 1 to 4. In addition, the communication circuit 14 disconnects the link with a communicating party when no responses are received for a certain period of time by measuring the time receiving no responses by using the timer 18. Therefore, the firmware 12 may only write data to be sent to each of the channels, from the memory 16 to the buffer 20 of the communication circuit 14 to instruct the data transfer. Thus, the load on firmware can be reduced.

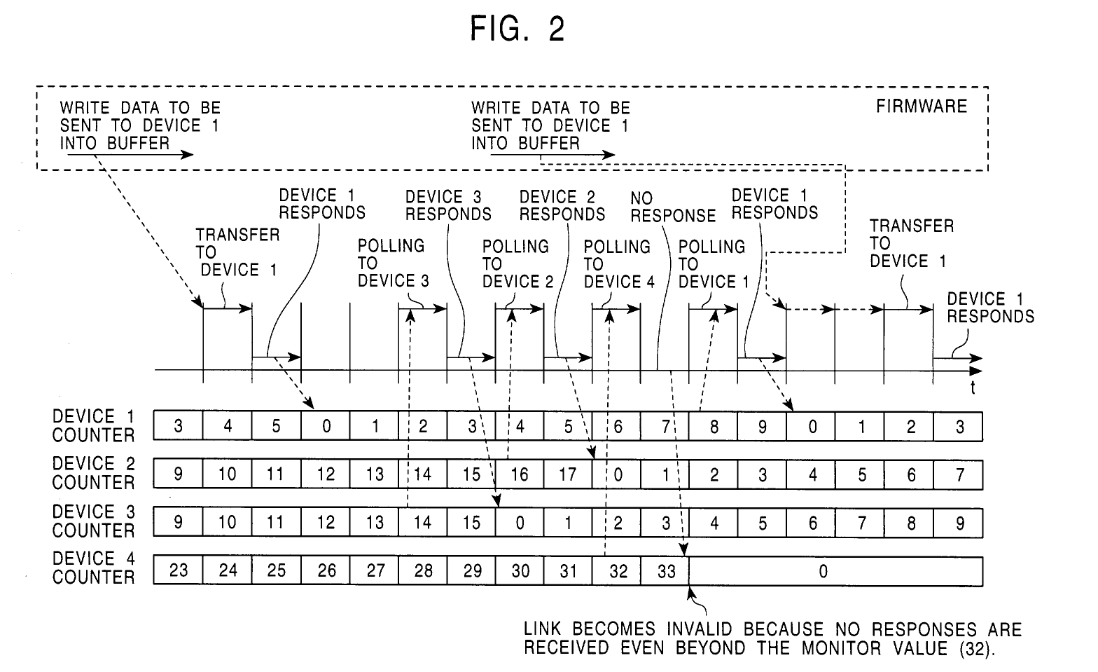

An operation of the data transfer device according to the present invention will be described below more specifically with reference to a timing chart shown in FIG. 2.

As described above, the counters corresponding to the devices 1 to 4, respectively, are up-counted for every time the communication channel is switched. In an example shown in the timing chart in FIG. 2, the count value of the counter for device 1 starts from ‘3’. Similarly, the count values of counters for the devices 2 and 3 start from ‘9’. The count value for the counter for the device 4 starts from ‘23’. In this way, each of the counters starts counting from a state where counting has been already started.

First of all, in the host device 10, under control of firmware, data to be transferred to the device 1 is written from the memory 16 into the buffer 20 of the communication circuit 14. Then, the data transfer is instructed. Thus, the data is transferred (sent) from the communication circuit 14 to the device 1. After received the data, the device 1 responds to the host device 10. In accordance with the response from the device 1, the counter for the device 1 is initialized, and the count value is cleared to ‘0 (zero)’.

Subsequently, when the count value of the counter for the device 3 reaches to ‘14’, which is a predetermined count value for performing polling, polling is performed automatically from the communication circuit 14 of the host device 10 to the device 3. Here, the device 3 responds to the host device 10 since the link between the device 3 and the host device 10 is still maintained. In accordance with the response from the device 3, the counter for the device 3 is initialized, and the count value is cleared to ‘0 (zero)’.

When the count value of the counter for the device 2 reaches to ‘16’, which is a predetermined count value for performing polling, polling is performed automatically from the communication circuit 14 of the host device 10 to the device 2. Like the case of the device 3, in accordance with the response from the device 2 to the host device 10, the counter for the device 2 is initialized, and the count value is cleared to ‘0 (zero)’.

When the count value of the counter for the device 4 reaches to ‘32’, which is a predetermined count value for performing polling, polling is performed from the communication circuit 14 of the host device 10 to the device 4. No responses from the device 4 are received by the host device 10 since the link with the host device 10 has been already disconnected. In this case, the counter for the device 4 is initialized, and the count value is cleared to ‘0 (zero)’. After that, the counter for the device 4 is not up-counted until the link is established again.

When the count value of the counter for the device 1 reaches to ‘8’, which is a predetermined count value for performing polling, polling is performed automatically from the communication circuit 14 of the host device 10 to the device 1. Like the case of the device 3, in accordance with the response from the device 1 to the host device 10, the counter for the device 1 is initialized, and the count value is cleared to ‘0 (zero)’.

Next, under control of the firmware of the host device 10, data to be sent to the device 1 is written in the communication circuit 14 again. Then, the data transfer is instructed. Here, in the communication circuit 14, a certain time lag occurs before the data transfer to the device 1 is started actually. Like the conventional case, the time lag may occur when other processing is performed in the communication circuit 14, or the time lag may occur when the data writing into the communication circuit 14 under control of the firmware takes time due to the serial transfer.

In the data transfer device according to the present invention, the communication circuit 14 assigns communication channels to the devices 1 to 4 independently from control by the firmware. In addition, in order to maintain or disconnect the link with a communicating party, the communication circuit 14 counts, by using the timer 18, a time that no responses are received and disconnects the link with the communicating party, which has not respond for a certain period of time. Therefore, the firmware 12 may only write data to be sent to the channels from the memory 16 to the buffer 20 of the communication circuit 14 to instruct data transfer.

Next, an internal construction of the data transfer device of the present invention will be described by using a more specific embodiment.

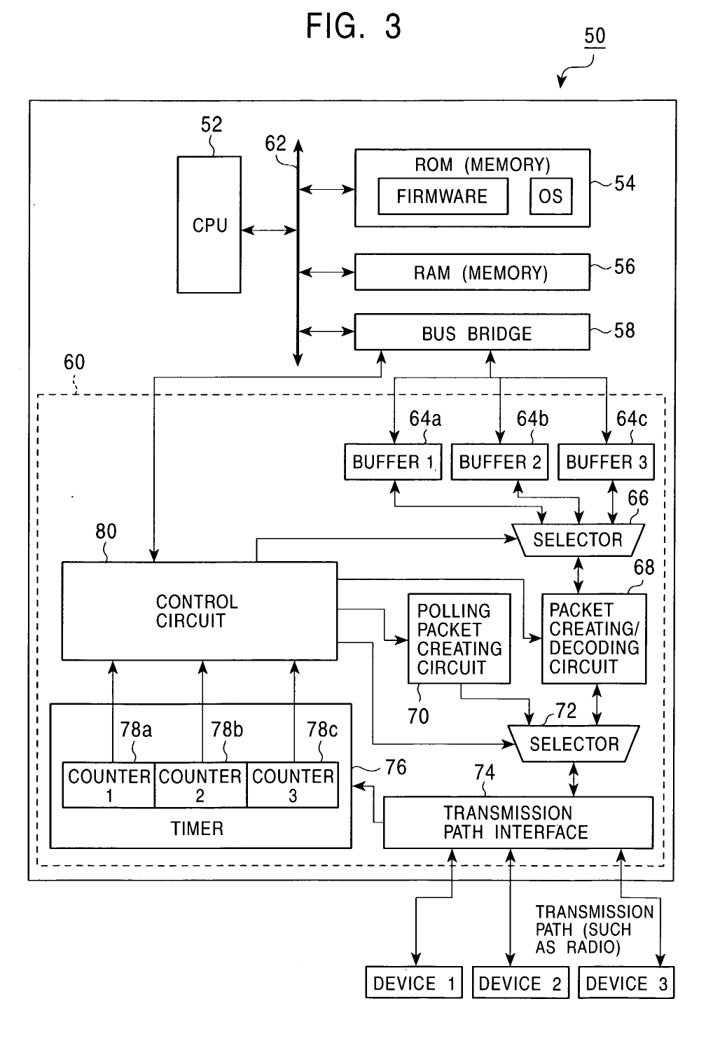

FIG. 3 is a conceptual diagram of one embodiment showing the internal construction of the data transfer device according to the present invention. A data transfer device (device A) 50 shown in FIG. 3 includes a central processing unit (CPU) 52, a ROM (nonvolatile memory) 54, a RAM (volatile memory) 56, a bus bridge 58 and a communication circuit 60. The CPU 52 controls an operation of the data transfer device 50. Firmware and an operating system (OS) are stored in the ROM 54. The RAM 56 holds data to be transferred.

Here, the CPU 52, the ROM 54, the RAM 56 and the bus-bridge 58 are connected to each other through a bus 62.

The communication circuit 60 includes buffers 64a, 64b and 64c (buffers 1 to 3), a selector 66, a packet creating/decoding circuit 68, polling packet creating circuit 70, a selector 72, a transmission path interface 74, a timer 76 and a control circuit 80. The timer 76 has three counters 78a, 78b and 78c (counters 1 to 3) provided by corresponding to the devices 1 to 3, respectively.

Here, the buffers 64a, 64b and 64c are connected to the bus bridge 58 on one end bidirectionally and connected to the selector 66 on the other end bidirectionally. The selector 66 is connected to the packet creating/decoding circuit 68 bidirectionally. The packet creating/decoding circuit 68 is connected to the selector 72 bidirectionally. The selector 72 is connected to the transmission path interface 74 bidirectionally. The devices 1 to 3 are connected to the transmission path interface 74 bidirectionally.

An output signal of the transmission path interface 74 is input to the timer 76. The output signals of the counters 78a, 78b and 78c of the timer 76 are input to the control circuit 80. The output signals of the control circuit 80 is input to the selector 66, the packet creating/decoding circuit 68, the polling packet creating circuit 70 and the selector 72. The control circuit 80 is connected to the bus bridge 58 to each other. The output signal of the polling packet creating circuit 70 is input to the selector 72.

The ROM 54, the RAM 56 and the communication circuit 60 in the data transfer device 50 respectively correspond to the memory 12, the memory 16 and the communication circuit 14 in the host device 10 shown in FIG. 1.

In the data transfer device 50 shown in FIG. 3, the firmware and the OS stored in the ROM 54 are read out through the bus 62 and are executed by the CPU 52 by using the RAM 56 as a work area. In other words, the CPU 52 operates in accordance with the program code of the firmware and the OS. Thus, the data transfer and the operation of the data transfer device 50 are controlled by the CPU 52.

When data is transferred from the device A to the devices 1 to 3, the data to be transferred is stored in the RAM 56 by an application operating on the OS, for example. The operation for transferring data from the device A to the device 1, for example, will be described below.

Under control of the CPU 52, the data held in the RAM 56 is read out through the bus 62 and is written in the buffer 64a of the communication circuit 60 through the bus bridge 58 interfacing with the bus 62. Through the bus bridge 58, the CPU 52 instructs the control circuit 80 to transfer the data to the device 1. Thus, in accordance with the output signal of the control circuit 80, the data in the buffer 64a is output selectively from the selector 66 and is input to the packet creating/decoding circuit 68.

In the packet creating/decoding circuit 68, a packet in accordance with a communication standard is created, including code for error correction, header information including identification information (ID) of a communicating party, and information regarding the packet itself, such as the packet length. The created packet is output from the selector 72 selectively in accordance with the output signal of the control circuit 80 and is input to the transmission path interface 74 for transferring data to the communicating party actually.

Then, the packet is sequentially transferred from the transmission path interface 74 to the device 1 through the transmission path such as the radio. In order to perform serial communication on the transmission path, for example, the transmission path interface 74 can convert parallel data to serial data and send the converted data to the communicating party. In addition, the transmission path interface 74 can receive serial data from a communicating party and convert the received serial data to parallel data. When the transmission path is the radio, the transmission path interface 74 has an interface function for the radio communication.

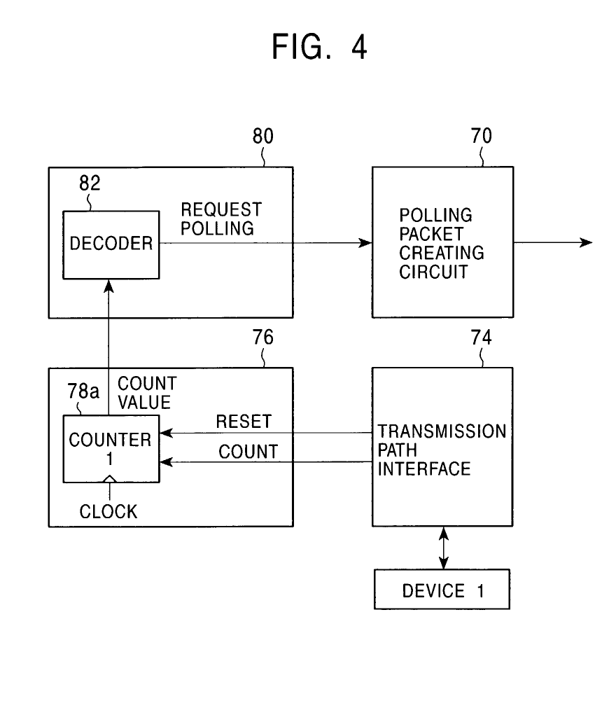

On the other hand, the device 1 responds to the device A after receiving data from the device A. As shown in FIG. 4 in detail, the transmission path interface 74 sends a reset signal to the timer 76 when receiving the response from the device 1. Thus, the counter 78a for the device 1 is initialized, and the count value is cleared to ‘0 (zero)’. The count values of the counters 78a, 78b and 78c are input to the control circuit 80 and are monitored by the control circuit 80 at all times.

The count values of the counters 78a, 78b and 78c are up-counted for every time the communication channel is switched. Here, as shown in FIG. 4, a count signal is transmitted from the transmission path interface 74 to the counter 78a, for example. In accordance with the clock signal, the counter 78a is up-counted. When the count value of the counter 78a reaches to a predetermined value for polling. the count value of the counter 78a is decoded and is detected by the decoder 82 of the control circuit 80. Then, the polling operation is performed.

In this case, as shown in FIG. 4, a polling request signal is transmitted from the control circuit 80 to the polling packet creating circuit 70. Then, a packet for polling is created by the polling packet creating circuit 70. The packet for polling is output selectively from the selector 72 in accordance with the output signal of the control circuit 80. Then, like data packet, the packet for polling is transferred from the transmission path interface 74 to the device 1 through the transmission path.

Here, if the device 1 responds to the device A, the link between both of them is maintained. In this case, the count value of the counter 78a is cleared to ‘0 (zero)’ and then is up-counted every time the communication channel is switched. On the other hand, if the device 1 does not respond to the device A, the link between both of them has been already disconnected. In this case, the count value of the counter 78a is cleared to ‘0 (zero)’ and then is not up-counted until the link is established again.

The operation performed by the device A, when the device 1 transfers data to the device A, is the same except that received packets are decoded and data sent from the device 1 to the device A is reconstructed in the packet creating/decoding circuit 68, instead of creating packets from data to be sent to the device 1.

In other words, packets sent from the device 1 to the device A is input to the packet creating/decoding circuit 68 through the transmission path interface 74 and the selector 72 of the device A. These packets are decoded and are reconstructed to the original data by the packet creating/decoding circuit 68 and are written in the buffer 64a through the selector 66. Then, the data is read out from the buffer 64a and is stored in the RAM 56 by way of the bus bridge 58 and the bus 62.

The operation for data communication between the device A and the device 2 or 3 is entirely the same.

As described above, in the data transfer device according to the present invention, the control by the firmware only needs to write and read data to be exchanged between the communicating devices to/from a communication circuit and to instruct the data transfer (or start the data transfer). Thus, the load on firmware is significantly reduced. The timer provided in the communication circuit is formed in hardware. Thus, the timer can operate fast, and time management of data transfer and channel assignment can be performed in real time. Thus, the communication channels can be used effectively.

The count value for polling can be set separately for a device of each communicating party. While Bluetooth is used as an example for the description, the present invention is not limited thereto. The present invention can be applied to the conventional, publicly known communication protocols regardless of wired or wireless and serial or parallel transfer. The number of communicating devices is not limited at all. The polling is not always required for maintaining a link. For example, interrupt processing may be used.

While a counter is used as the timer in the embodiment for description, the counter may be an up-counter or a down-counter. The present invention is not limited to the counter. The timer may be any type of conventional, publicly known timer. The specific internal construction of the data transfer device according to the present invention is not limited to the example shown in FIG. 3. Processing for creating a packet from data or processing for creating a polling packet may be applied as necessary.

While the data transfer device according to the present invention was described in detail above, the present invention is not limited to the above-described embodiments. Various improvements and/or modification on the present invention are possible without departing from the principle of the present invention.

What is claimed is:

1. A data transfer device, comprising:
a memory for storing firmware for controlling data transfer; and
a communication circuit for transferring data under control of the firmware,
wherein the communication circuit has a timer for measuring a time and controls a communicating party in accordance with the value measured by the timer independently from the control of the firmware.

2. A data transfer device according to claim 1, wherein the communication circuit further has at least one buffer provided by corresponding to a communicating party in the one-to-one manner for temporally holding data to be transferred, a transmission path interface for exchanging data with a communicating party through a transmission path and a control circuit for controlling an operation of the communication circuit.

3. A data transfer device according to claim 1, wherein the timer has at least one counter provided by corresponding to a communicating party in the one-to-one manner, and wherein the counter is counted every time a communication channel is switched and is initialized in receipt of a response from a corresponding communicating party.

4. A data transfer device according to claim 2, wherein the timer has at least one counter provided by corresponding to a communicating party in the one-to-one manner, and wherein the counter is counted every time a communication channel is switched and is initialized in receipt of a response from a corresponding communicating party.

5. A data transfer device according to claim 2, wherein the communication circuit further includes a packet creating/decoding circuit for creating a packet from data to be sent to the communicating party, and inputting the packet to the transmission path interface, and for decoding the packet received from the communicating party through the transmission path interface, reconstructing the original data.

6. A data transfer device according to claim 5, wherein the timer has at least one counter provided by corresponding to a communicating party in the one-to-one manner, and wherein the counter is counted every time a communication channel is switched and is initialized in receipt of a response from a corresponding communicating party.

7. A data transfer device according to claim 6, wherein the control circuit has a function for outputting a polling request signal for a communicating party corresponding to the counter when a count value of the counter reaches to a predetermined value.

8. A data transfer device according to claim 7, wherein the communication circuit further includes a polling packet creating circuit for creating a polling packet in accordance with an instruction from the control circuit.

9. A data transfer device, comprising:
a memory for storing firmware for controlling data transfer;
a CPU for executing the firmware; and
a communication circuit for transferring data under control of the firmware,
wherein the communication circuit has a counter for counting a number of times of switching communication channels and controls a communicating party in accordance with the measured value of the counter separately from the control of the firmware.

10. A data transfer device according to claim 9, wherein the memory for storing the firmware is a nonvolatile memory.

11. A data transfer device according to claim 9, wherein the counter is provided by corresponding to a communicating party in the one-to-one manner.

12. A data transfer device according to claim 11, wherein the communication circuit includes at least one buffer provided by corresponding to a communicating party in the one-to-one manner for temporally holding data to be transferred, a transmission path interface for exchanging data with a communicating party through a transmission path, and a control circuit for controlling an operation of the communication circuit.

13. A data transfer device according to claim 12, wherein the communication circuit further includes a packet creating/decoding circuit for creating a packet from data to be sent to the communicating party, and inputting the packet to the transmission path interface, and for decoding the packet received from the communicating party through the transmission path interface, reconstructing the original data.

14. A data transfer device according to claim 13, wherein the control circuit has a function for outputting a polling request signal to a communicating party corresponding to the counter when a count value of the counter reaches to a predetermined value.

15. A data transfer device according to claim 14, wherein the control circuit further has a function for disconnecting a link with the corresponding communicating party when the corresponding communicating party does not respond.

16. A data transfer device according to claim 14, wherein the communication circuit further includes a polling packet creating circuit for creating a polling packet in accordance with an instruction from the control circuit.

17. A data transfer device, comprising:
a memory for storing firmware for controlling data transfer,
a CPU for executing the firmware; and
a communication circuit for transferring data under control of the firmware,
wherein the communication circuit includes at least one buffer provided by corresponding to a communicating party in the one-to-one manner for temporally holding data to be transferred, a transmission path interface for exchanging data with the communicating party through a transmission path, at least one counter provided by corresponding to a communicating party in the one-to-one manner for counting a number of times of switching communication channels and for being initialized in receipt of a response from the corresponding communicating party, and a control circuit for controlling an operation of the communication circuit; and
wherein the communication circuit controls the communication party independently from the control of the firmware.

18. A data transfer device according to claim 17, wherein the communication circuit further includes a packet creating/decoding circuit for creating a packet from data to be sent to the communicating party, and inputting the packet to the transmission path interface, and for decoding the packet received from the communicating party through the transmission path interface, reconstructing the original data.

19. A data transfer device according to claim 18, wherein the control circuit has a function for outputting a polling request signal to a communicating party corresponding to the counter when a count value of the counter reaches to a predetermined value.

20. A data transfer device according to claim 19, wherein the communication circuit further includes a polling packet creating circuit for creating a polling packet in accordance with an instruction from the control circuit.
